(19) United States
(12) Patent Application Publication
(10) Pub. No.: US 2026/0124607 A1
(43) Pub. Date: May 7, 2026

(54) METHOD FOR PRODUCING HYDROISOMERIZED AND/OR HYDROCRACKED HYDROCARBONS WITH HIERARCHICAL ZEOLITIC MATERIALS

(71) Applicant: UOP LLC, Des Plaines, IL (US)

(72) Inventors: Melanie Schaal, Schaumburg, IL (US); Susan C. Koster, Carpentersville, IL (US); William Christopher Sheets, Glenview, IL (US); Kelsey L. Hodge, Hoffman Estates, IL (US); Mimoza Sylejmani-Rekaliu, Bensenville, IL (US); Jaime G. Moscoso, Mount Prospect, IL (US); Paula L. Bogdan, Mount Prospect, IL (US)

(21) Appl. No.: 19/370,357

(22) Filed: Oct. 27, 2025

Related U.S. Application Data
(60) Provisional application No. 63/715,795, filed on Nov. 4, 2024.

(51) Int. Cl. B01J 29/80; C10G 49/08

(52) U.S. Cl. CPC B01J 29/80; C10G 49/08; C10G 2300/70

(57) ABSTRACT

Methods for converting hydrocarbonaceous feedstocks to value added products via a hydroisomerization/hydrocracking catalyst that contains at least two or more zeolitic materials comprising hierarchical porosity, each material having a mesostructure between 2-50 nm are described. Specifically, the improved acid function in these catalysts is obtained by mesoporizing a first zeolite and blending the mesoporized first zeolite with an as-synthesized mesoporous second zeolite; or mesoporizing a first zeolite; mesoporizing a second zeolite, and blending the mesoporized first zeolite with the mesoporized second zeolite; or blending a first zeolite and a second zeolite; and mesoporizing the blend of the first zeolite and the second zeolite; wherein the first zeolite comprises Y zeolite, and the second zeolite comprises a one-dimensional, 10-ring zeolite.

### RELATED APPLICATIONS

This application claims priority to U.S. Provisional Patent Application Ser. No. 63/715,795, filed on Nov. 4, 2024, the entirety of which is incorporated herein by reference.

### FIELD OF THE INVENTION

This invention relates to a method for converting various relatively high carbon number feed stocks into higher value products via a hydroisomerization and/or hydrocracking catalyst containing at least two or more zeolitic materials comprising hierarchical porosity, each material having a mesostructure between 2-50 nm.

### BACKGROUND OF THE INVENTION

The field of art to which this invention pertains is the hydroisomerization and/or hydrocracking of a hydrocarbonaceous feedstocks. When formulated into catalysts, inclusion of mesoporous or hierarchical zeolites can be beneficial in several different applications such as hydrocracking, hydrocracking for lube base oil production, dewaxing, conversion of biogenic materials to biofuels, conversion of Fisher Tropsch products to sustainable aviation fuel, and the like.

Hydroprocessing can include processes in which hydrocarbons are converted in the presence of a hydroprocessing catalyst and hydrogen to more valuable products. Hydrocracking is a hydroprocessing process in which hydrocarbons crack in the presence of hydrogen and a hydrocracking catalyst to lower molecular weight hydrocarbons. Depending on the desired output, a hydrocracking unit may contain one or more fixed beds of the same or different catalyst. Typically, the hydrocracking process is employed to crack hydrocarbon feeds such as vacuum gas oil (VGO) to products such as diesel fuel, jet fuel, kerosene, and gasoline motor fuels. Hydrocracking can be achieved in one or more stages. Usually, in a hydrocracking process, a hydrocracked effluent is fractionated which produces various fractions including an unconverted oil which may be recycled. In hydrocracking to produce lube oils, the feed stream is typically hydrogenated and isomerized; mild hydrocracking to smaller molecules may also occur. In that case, the properties of the unconverted oil are important in order to meet viscosity index requirements.

In catalytic dewaxing, the content of high molecular weight n-paraffins in the feed stream is reduced through isomerization and/or mild cracking by exposing the feed to the catalyst in the presence of hydrogen at elevated pressures and temperatures. The goal is to improve the pour point of the feed stream.

Biogenic materials can be converted to biofuels. For example, a wide range of waste fats, oils, and greases or feedstocks such as oil crops (i.e., biomass) can be converted into sustainable aviation fuel (SAF), which is a low-carbon alternative to conventional, petroleum-based jet fuel. For additional information regarding the conversion to biofuels, refer to WO 2008/058664, EP 1728844, WO 2009/039347, WO 2009/039335, WO 2009/039333, WO 2009/158268, and U.S. Pat. No. 7,915,460.

The Fischer-Tropsch process involves converting synthesis gas comprising carbon monoxide and hydrogen to hydrocarbons using a heterogeneous catalyst. Fischer-Tropsch synthesis is known to yield a broad mixture of products including primarily paraffins, and some olefins. The individual compounds of such mixture can contain up to about 200 carbons. Typically, the number of carbons is between about 1 and about 150, with an average number of carbons of about 30. Such feed stocks are suitable for conversion into sustainable aviation fuel by subsequently selectively hydrocracking and/or hydroisomerizing the Fischer-Tropsch product stream in order to obtain the desired product slate and product properties. In this case, the hydrocracking reaction conditions may comprise a temperature in a range of 315° C. to 430° C., and/or a pressure in a range of 300-1000 psig. The hydrocracking catalyst may comprise Y zeolite, beta zeolite, SiO₂—Al₂O₃, noble metals, base metals, or combinations thereof.

Catalysts in the described processes generally contain a metal function and an acid function, and catalyst selection has a notable impact on both the product slate and product properties. In many cases, the acid function may be supplied by incorporating a zeolite with a suitable silica-alumina ratio to achieve the desired conversions while maintaining specific, desirable product properties. For example, the prior art hydrocracking catalysts will typically comprise one or more components selected from silica, alumina, silica-alumina, crystalline aluminosilicate, or other refractory inorganic oxide and at least one metal component from Group 6 or Groups 8-10. One or more hydrogenation components have been selected by the prior art to serve as the hydrogenation component in hydroconversion catalysts. The prior art has broadly taught that hydrogenation components may be selected from at least one of the following metals: iron, cobalt, nickel, ruthenium, rhodium, palladium, osmium, iridium, platinum, chromium, molybdenum, tungsten, vanadium, niobium, and tantalum.

Zeolites are classified by the Structure Commission of the International Zeolite Association according to the rules of the IUPAC Commission on Zeolite Nomenclature. Framework type zeolites, for which a structure has been established, and are assigned a three-letter code. A database of the assigned framework codes is provided in the “Atlas of Zeolite Framework Types” 6^{th} Ed., Elsevier (2007). More recently, the Database of Molecular Sieve Structures has been maintained on the International Zeolite Association's website (http://www.iza-online.org).

Y zeolites (FAU topology) have a 3-dimensional, 12-membered ring structure. They are commonly used for the catalytic cracking of heavy petroleum fractions to produce lighter hydrocarbons, like gasoline, naphtha, or distillate, owing to their relatively large diameter interconnected pores.

Y zeolites are prepared hydrothermally from a synthesis gel. The preparation of typical silica sols is described in U.S. Pat. Nos. 2,574,902 and 2,597,872. As-synthesized Y zeolites have a significant amount of aluminum in their framework with a SiO₂/Al₂O₃ ratio greater than 3 and unit cell size greater than 24.6 angstroms up to 24.85 angstroms (Å). In many cases, Y zeolites cannot be used in catalysts as-synthesized and have been subjected to certain stabilizing and/or dealumination post-synthesis treatments for use in catalyst formulations, such as steaming, hydrothermal, acid-washing, and/or cation exchanging.

Y zeolites above a SiO₂/Al₂O₃ ratio of 4.4 may be dealuminated in steam without having the framework collapse, i.e., hydrothermal stability. U.S. Pat. Nos. 5,069,890 and 5,087,348 teach a method of preparing a Y zeolite with greater SiO₂/Al₂O₃ ratio by steaming the Y zeolite for numerous hours, typically 16 to 24 hours. The steaming process removes the aluminum from the framework, generating non-framework aluminum. Different steam temperatures and exposure times can be used to obtain Y zeolites with different framework aluminum content, and therefore different framework SiO₂/Al₂O₃ ratios. U.S. Pat. No. 5,601,798 discloses a method of increasing the mesopore volume of Y zeolites by treatment using a hydrothermal aqueous solution, which is different from steaming because a component of the water remains in the liquid state. Steam and/or hydrothermal treatments impact the unit cell size, acid strength, morphology, and porosity of Y zeolites. Those skilled in the art understand that such changes can be monitored using appropriate characterization techniques, like x-ray diffraction (XRD), x-ray fluorescence (XRF), inductively coupled plasma (ICP), infrared spectroscopy (IR), electron microscopy, nuclear magnetic resonance (NMR), and gas sorption, among others.

Acid treatment can also be used on Y zeolites to remove framework and/or non-framework aluminum. U.S. Pat. No. 5,112,473 teaches a method to increase the SiO₂/Al₂O₃ ratio of Y zeolites to between 10-120 and generate a small increase in mesopore volume by treating the Y zeolite in a 0.5 M aqueous solution of nitric acid at 60° C. for 2 hours. Different temperatures, times, and mineral acids, such as sulfuric acid, hydrochloric, phosphoric acid, and/or organic acids, like ethylenediaminetetraacetic acid, malic acid, tartaric acid, citric acid, or oxalic acid, can be used. Acid treatments impact the unit cell size, acid strength, morphology, and porosity of Y zeolites.

Y zeolites typically exist in alkali metal form, alkaline earth metal form, or mixed forms after their synthesis, owing to the common use of these cations in the synthesis gel. For catalytic applications that use a zeolite as a solid acid catalyst, it is desirable that most or all the original zeolitic charge-balancing cations be replaced with hydronium cations. In certain cases, direct acid treatment of the zeolites can replace the less desirable cation with the hydronium cation. More commonly, the as-synthesized zeolites may be ion-exchanged with an ammonium salt followed by heating to decompose the ammonium ions associated with the zeolite, leaving in their place hydronium ions and/or exchange sites which have been decationized by further removal of water. Hydronium or “decationized” Y zeolites of this nature are more particularly described in U.S. Pat. No. 3,100,006. Ion-exchanges can also be used to replace a certain portion of the less desirable charge-balancing cations with other preferred cations. Mixed polyvalent metal-hydronium zeolites may be prepared by ion-exchanging first with an ammonium salt, then partially back exchanging with a polyvalent metal salt, and then calcining.

The same post-synthesis steam, acid, and ion exchange treatments can be applied to other zeolite topologies to increase their SiO₂/Al₂O₃ ratio, activate their solid acid sites, and/or generate mesopores (see Zeolites in Industrial Separation and Catalysis, John Wiley & Sons, 2010).

A second zeolite may be blended with the Y zeolite in the catalyst formulation to improve its activity, stability, and/or the yields of desired products. U.S. Pat. No. 5,160,033 describes the use of a blend of a steam-stabilized form of zeolite Y and a modified form of zeolite beta (*BEA topology) that provides a uniquely effective acidic component of a hydrocracking catalyst to produce gasoline. While zeolite beta has been reported to improve product yields, U.S. Pat. No. 4,983,273 teaches that it has a strong paraffin selectivity when used with a distillate feedstock containing a mixture of aromatics and paraffins, resulting in a significant portion of the aromatic compounds remaining in the unconverted oil while the paraffins are converted to the desired products. Thus, blending a Y zeolite with a different zeolite may be particularly useful in applications where higher total distillate yields are desirable, but aromatic content in the unconverted oil is less preferred.

A one-dimensional zeolite may be blended with the Y zeolite in the catalyst formulation to improve its activity, stability, and/or the yields of desired products. U.S. Pat. No. 5,762,900 teaches preparing a hydrocracking catalyst comprising a combined FAU-type zeolite and TON-type zeolite (one-dimensional, 10-ring zeolites) along with an amorphous or low crystallinity matrix to maximize the yield of middle distillates. U.S. Pat. No. 8,119,552 discloses a catalyst composition for the reaction of hydrocarbons comprising a faujasite zeolite and a fibrous zeolite, which comprises non-crossing one-dimensional channels. It is claimed that the use of fibrous zeolites with a one-dimensional channel structure provides an advantageous product distribution and/or an increased catalyst stability with reduced formation of coke precursors.

Zeolites with a one-dimensional, 10-ring zeolite topology, like EU-1, ZSM-22, ZSM-23, or ZSM-48, are used commonly in catalysts for dewaxing low-quality feedstocks. Dewaxing catalysts isomerize linear chain molecules, also known as waxy feedstocks, into branched chain molecules. Branched chain molecules can have desirable properties, like improved viscosity index (VI) and pour points. ZSM-22, ZSM-23, and ZSM-48 demonstrate good catalytic performance because of their one-dimensional (1D) pore structure and appropriate acidity. One-dimensional zeolites have gained widespread interest in hydrocracking studies due to their improved product yields. However, their fast deactivation, which was attributed to slow diffusion and pore mouth blockage, hinders their utilization in commercial applications. Hierarchical, mesoporous, and nanozeolite one-dimensional, 10-ring zeolites have been tested to improve the diffusion of reactants and products, and therefore reduce deactivation, with promising results (see Catal. Today, 2019, vol. 324, pp. 3; Chem. Eng. Sci., 2024, vol. 287, pp. 119785). This highlights the role of mass transfer limitations in one-dimensional zeolites influencing product yields of catalytic reactions.

ZSM-48 (*MRE topology) zeolites have an orthorhombic cell in the Pmma space group with typical unit cell dimensions of a=14.24 Å, b=20.14 Å, and c=8.40 Å, calculated based on data collected using X-ray crystallography (see Zeolites, 1985, vol. 5, pp. 355-358). ZSM-48 is a type of high-silica zeolite with a silica to alumina ratio typically greater than 100. It is considered a one-dimension zeolite because it contains only one channel greater than a 6-membered ring, a 10-membered ring (10-MR) channel (5.3×5.6 Å) along the direction. The structure of ZSM-48 zeolite is complex because its framework is a highly disordered intergrowth of numerous structurally related polytypes, leading to sharp and broad features in the X-ray diffraction (XRD) powder pattern (see, J. Am. Chem. Soc., 2002, vol. 124, pp. 13222-13230). These disordered intergrowths do not disrupt the one-dimensional channel system. This disordered *MRE structure is typical of several types of crystalline materials, like ZSM-48, EU-2, ZSM-30, SSZ-91 and EU-11, that are produced by different entities and differ in their chemical composition, morphology, and synthesis methods.

ZSM-48 zeolites are synthesized typically between 100-200° C. for three days using a hydrothermal synthesis method. The initial synthesis gel typically contains an alumina and silica source along with organic structure directing agents, such as n-propylamine and/or tetramethylammonium chloride. A caustic, such as sodium hydroxide, is added to the gel to provide hydroxide ions. ZSM-48 is considered one of the most promising candidates in hydroisomerization reactions because mono-branched hydrocarbons can diffuse freely and multibranched hydrocarbons are suppressed due to the shape selectivity of the ZSM-48 channels. U.S. Pat. No. 7,625,478 teaches how the dewaxing performance of ZSM-48 can be further improved through synthesizing desirable morphologies and physically mixing zeolites.

ZSM-22 zeolites (TON topology), also known at Theta-1, NU-10, KZ-2, or ISI-1 zeolites, are highly siliceous zeolites that have an orthorhombic cell in the Cmc21 space group with typical unit cell dimensions of a=13.86 Å, b=17.42 Å, and c=5.04 Å, calculated based on data collected using X-ray crystallography (see Atlas of Zeolite Framework Types, 6^{th} ed.” 2007). It is considered a one-dimension zeolite because it contains only one channel greater than a 6-membered ring, an oval-shaped 10-membered ring (10-MR) channel (4.5×5.5 Å) along the direction.

ZSM-22 zeolites are synthesized typically at 150-170° C., for 1 to 4 days using a hydrothermal synthesis method. U.S. Pat. No. 5,336,478 teaches a method suitable for producing ZSM-22 synthesized from an initial gel that typically contains an alumina and silica source along with an alkali hydroxide, such as potassium hydroxide, and alkane diamine organic structure directing agents, such as butanediamine, hexanediamine, decanediamine, and/or lauryl amine. The different alkane diamine organic structure directing agents and others are used during the synthesis to control the morphology and porosity of ZSM-22 particles along with their SiO₂/Al₂O₃ and acidity (see Ind. Eng. Chem. Res., 2023, vol. 62. pp. 11470-11479).

ZSM-23 zeolites (MTT topology) have an orthorhombic cell in the Pmmn space group with typical unit cell dimensions of a=5.26 Å, b=22.03 Å, and c=11.38 Å, calculated based on data collected using X-ray crystallography (see Atlas of Zeolite Framework Types, 6^{th} ed.” 2007). It is considered a one-dimension zeolite because it contains only one channel greater than a 6-membered ring, a teardrop-shaped 10-membered ring (10-MR) channel (4.5×5.2 Å) along the direction. This MTT structure is typical of several types of crystalline materials, such as ZSM-23, SSZ-32, SSZ-95, EU-13, ISI-4, and KZ-1, that are produced by different entities and differ in their chemical composition, morphology, and synthesis methods.

ZSM-23 zeolites are synthesized typically between 100-205° C. for 1 to 7 days using a hydrothermal synthesis method. U.S. Pat. No. 4,076,842 teaches a method suitable for producing ZSM-23 synthesized from an initial gel that typically contains an alumina and silica source along with organic structure directing agents, such as mixtures containing pyrrolidine. U.S. Pat. No. 4,490,342 teaches the use of a diquaternary ammonium cations, designated Diquat-7, for an improved synthesis procedure. The synthesis parameters influence the shape and size of ZSM-23 zeolite crystals. Different amine organic structure directing agents, like a series of diquats, ethylamine, isopropylamine, and dimethyl formamide, are used during the synthesis to control the morphology and porosity of ZSM-23 particles along with their SiO₂/Al₂O₃ and acidity (see Pet. (hem., 2021, vol. 61. pp. 276-283).

Mesoporous and/or Hierarchical Zeolites

In many catalytic applications, zeolites comprised of micrometer sized particles and containing a modicum of mesopores and/or macropores volumes impose diffusional limitations on the reaction rate. The diffusional limits may decrease yields of the desired products, increase coking, and reduce catalyst lifetimes.

Numerous strategies have been pursued to circumvent the problem of diffusional limitations in certain zeolites, thereby creating hierarchical zeolites that contain a mixture of micropores, mesopores, and macropores. A variety of synthesis schemes have been reported to prepare small zeolite crystallites, often referred to as nanozeolites, that contain mesopores and macropores because of the crystallites aggregating into larger particles that contain gaps. Zeolites have also been synthesized from gels containing porogens, like carbon black, that are removed selectively post-synthesis to create mesopores and/or macropores.

Zeolites with a one-dimensional, 10-ring zeolite topology, like ZSM-23 or ZSM-48, have been prepared by methods that yield a product with significant mesopore volumes and/or mesopore surface areas. The mesopores exist typically as the space between aggregates of small crystallites. A mesoporous ZSM-48 zeolite composed of aggregates of small crystallites can be prepared directly by synthesis using the organic structure directing agent 1,6-hexylenediamine (see ACS Appl. Mater. Interfaces, 2021, vol. 13, pp. 31756). Seed-assisted syntheses of ZSM-23 yield aggregates of needle-like crystallites that possess increased mesopore surface areas compared to ZSM-23 zeolites synthesized without zeolite seeds (see Micro. Meso. Mater., 2017, vol. 252, pp. 146-153).

U.S. Pat. No. 10,919,028 teaches a method to prepare zeolite X and Y (FAU topology) nanocrystals. The Y nanocrystals combine into polycrystalline aggregates, and the gaps between the crystallites create significant mesopore volumes. The relatively low SiO₂/Al₂O₃ ratio of the as-synthesized Y zeolite nanocrystals, e.g., less than 4.0, and significant amount of residual sodium from the synthesis make the as-synthesized Y zeolites non-ideal for catalytic applications. Many Y zeolite nanocrystals are not stable to the steaming, acid treatment, and/or ion-exchange required to convert the Y zeolite into a form usable in catalytic applications.

Other approaches to prepare mesoporous zeolites focus on post-synthesis treatments to introduce hierarchical porosity and mesoporosity beyond what can be achieved by state-of-the-art steam and acid treatments. Such post-synthesis treatments also allow the properties of the zeolite, such as silica to alumina (SiO₂/Al₂O₃) ratio, charge balancing cation composition, and acidity to be tuned for the catalytic application.

A significant focus has been on preparing hierarchical and/or mesoporous Y zeolites with post-synthesis treatments, owing to their ubiquitous use in industrially important catalysts and adsorbents. Numerous post-synthesis techniques that generate Y and other zeolites having hierarchical porosity and/or mesoporosity have thus been listed in the literature (see Catal. Sci. Technol., 2011, 1, 879 and Chem. Soc. Rev., 2016, 45, 3331). U.S. Pat. No. 6,669,924 teaches how to synthesize a mesoporous zeolitic material having uniformly sized mesopores. U.S. Pat. No. 8,007,663 and US20230191375 teaches how to prepare mesostructured zeolites using a post-synthesis treatment using an aqueous mixture of caustic and surfactant at elevated temperatures, as well as using them as cracking catalysts for organic compounds. U.S. Pat. No. 11,325,835, US20230051097, and WO2024194193 teach how to prepare mesoporous zeolites using a process to perform controlled alkaline treatments with pore-directing agents, yielding improved catalytic properties.

Similar post-synthesis treatments have been applied to one-dimensional, 10-ring zeolites to increase their mesopore volumes. Post-synthesis alkaline and acid treatments of ZSM-48 crystals increase their mesopore volume (see Energy Fuels, 2017, vol. 31, pp. 14097-14103). The ZSM-48 with improved mesoporosity exhibited increased hexane cracking activity compared to its parent ZSM-48, which the authors attributed to better diffusion through the mesoporous ZSM-48. A similar post-synthesis alkaline and then acid treatments of ZSM-22 crystals increase their mesopore volume (see Cryst. Eng. Comm., 2011, vol. 13, pp. 3408-3416). The authors noted that the introduction of mesoporosity was not straightforward due to the rod-like crystal shape and uneven aluminum distribution of the ZSM-22 parent zeolite, which emphasizes that each post synthesis treatment must be optimized for the specific zeolite. The crystal morphology of ZSM-22 was again cited as the dominant parameter impacting formation of mesopores when different alkaline treatments were applied, including those with and without pore directing agents and/or surfactants (see Catal. Today, 2018, vol. 299, pp. 120-134). The addition of pore-directing agents and/surfactants changed the amount and distribution of the mesopores in the ZSM-22 crystals. Post-synthesis alkaline and then acid treatment of ZSM-23 crystals increases their mesopore volumes (see Micro. Meso. Mater., 2019, vol. 209, pp. 109647). The authors report that the hierarchical zeolites have an increased catalytic activity of n-heptane cracking and lower rate of deactivation by coke deposition versus their parent zeolites.

There exists a desire to prepare a catalyst composition which, when used in a catalytic cracking process, can improve the total product yield and transform both the paraffins and aromatics components of the feedstocks into desired products. This invention focuses on improvements to the acid function, more specifically, improvements to a blend of Y and one-dimensional, 10-ring zeolites.

### DESCRIPTION

Processes for hydroisomerization and/or hydrocracking hydrocarbonaceous feedstocks have been developed wherein the use of a novel hydroisomerization/hydrocracking catalyst comprising at least two or more zeolitic materials comprising structured hierarchical porosity results in improved desired product yields. It has been found, in a surprising manner, that a catalyst composition comprising a blend of a mesoporous Y zeolite; a mesoporous one-dimensional, 10-ring zeolite, like ZSM-22 or ZSM-23 or ZSM-48; and a noble or base metal hydrogenation metal function such as Ni, Co, Mo, W, Mn, Cu, Zn, Ru, Pd, Pt, and combinations thereof demonstrate superior catalytic performance over similar catalyst compositions free of either a mesoporous Y zeolite or a mesoporous one-dimensional, 10-ring zeolite.

In the embodiments below, zeolites will be described in terms of “as-synthesized” or “as-received” or “parent” that represent the form of the zeolite crystals when they arrive from an internal or external supplier. Such zeolites may have been calcined and/or ion-exchanged after their synthesis by the supplier to remove organic templates and/or change the cation form, respectively. Certain as-received zeolites may have been steamed and/or acid-treated by the supplier to modify their particle morphology, porosity, acidity, and SiO₂/Al₂O₃ ratio.

Certain zeolites will be described in terms of “Y” or “Y zeolite” or “zeolite Y” or “high-silica faujasite” or “FAU-type” that have the structure and framework properties attributed to the code FAU by the International Zeolite Association. Y zeolites are FAU zeolites that possess a SiO₂/Al₂O₃ ratio greater than 3. The aluminum in zeolite Y can be removed by acid and/or steam treatments to increase the SiO₂/Al₂O₃ ratio significantly, and the resulting Y zeolite is called “ultrastable zeolite Y” or “USY”, owing to its increased stability under aggressive steam calcination conditions.

Certain zeolites will be described in terms of “one-dimensional” or “1D” that have a single crystallographic direction where there exists a significant pore opening. Those skilled in the art understand that the International Zeolite Association states that there are two different ways the channel dimensionality is defined: topological dimensionality and dimensionality with respect to the sorption of an organic molecule. In the topological dimensionality, any channel that has a pore opening larger than a 6-ring is considered a channel, irrespective of the actual geometric pore opening. In the sorption dimensionality, only channel directions that have a pore opening larger than 3.4 Å are counted. The value of 3.4 Å has been chosen to be small enough to allow for certain variation in the actual pore openings of a material, but not too small to be unrealistic. Thus, the sorption dimensionality will provide a guide to whether a small or slim organic molecule might be able to diffuse along a channel direction.

Other zeolites will be described in terms of “10 ring” or “10R” that represent the number of tetrahedral sites (T-sites) that delimit the pore openings. Those skilled in the art understand the zeolites are characterized by their differences in the size and shapes of the features present in the crystal. Ring sizes are one common type of feature widely reported and used, both to characterize a zeolite crystal and as descriptors of the individual T-sites of a zeolite. Rings have been used to describe the similarity between zeolites, the channel sizes for understanding shape selectivity in catalysis, and the sizes of framework cages and windows to provide insights into adsorption properties. The dimension and number of rings in a framework can be used to characterize entire zeolite frameworks, T-sites that make up these frameworks, or even the oxygen atoms that connect the T-sites.

Certain zeolites will be described in terms of “one-dimensional, 10-ring zeolite topology” that include the zeolites ZSM-22, ZSM-23, or ZSM-48. For catalysts according to the invention that incorporate ZSM-48 and/or a related *MRE topology zeolite, any suitable method for producing them may be used. For catalysts according to this invention that incorporate ZSM-22 and/or a related TON topology zeolite, any suitable method for producing them may be used. For catalysts according to this invention that incorporate ZSM-23 and/or a related MTT topology zeolite, any suitable method for producing them may be used.

Certain treatments will be described as “post-synthesis” that were thermal, hydrothermal, and/or chemical methods applied to as-received zeolite crystals. Such treatments, described below in more detail, include aqueous alkaline and/or acid treatment at increased temperatures that change the particle morphology, porosity, acidity, and SiO₂/Al₂O₃ ratio of the zeolite. Other post synthesis treatments that are performed to prepare a zeolite for use in catalyst formulation include steaming, milling, sieving, extruding, peptizing, calcining, ion-exchanging, and the like.

Certain zeolites will be described in terms of “ion-exchanged” or “ammonium-exchanged” that were mixed in an aqueous solution of at least 0.1 mol/L ammonium nitrate at 20 to 80° C. for 1 to 3 hours. Those skilled in the art understand that the exact reagent concentration, temperature, and time used for an ion-exchange reaction depend on the exchange isotherm for the cations involved. The solid product can be recovered from the slurry by vacuum filtration or centrifugation. The recovered solid may be washed with deionized water. The ion-exchange process may be repeated until the desired cation composition is achieved in the zeolite product. The charge balancing cation of the zeolite being used in catalyst formulation may be in the ammonium form, in an exchanged form (i.e., a form in which any alkali metal present has been exchanged for one or more rare earth metals), or preferably in the hydronium form. Alkali metal is present preferably in the amount of less than about 0.5 wt. % to minimize poisoning of the solid acid sites in the zeolite.

Certain zeolites will be described in terms of “calcined” that were heated in a furnace at 500 to 750° C. under flowing air or pure nitrogen or a mixture thereof to remove any residual organic components. A typical range of heating and cooling rates for calcination includes 0.5 to 5° C. per minute.

Certain zeolites will be described in terms of “activated” that were ammonium-exchanged zeolites heated in a furnace to at least 400° C. under flowing air at 20 to 100 standard cubic feet per hour to decompose the ammonium cation through the elimination of ammonia. This creates a zeolite product in the “proton form” or “hydronium form” or “H-form” that can be used as a solid acid catalyst. It is common to refer to a Y zeolite that has been activated to the H-form as a HY or H-Y zeolite.

As used herein, certain zeolites will be described in terms of “mesoporous” or “hierarchical” that possess a mesopore volume greater than 0.10 cc/g. In the context of physisorption, the International Union of Pure and Applied Chemistry (IUPAC) defines pores according to their size: pores with widths exceeding about 50 nm are called macropores, pores of widths between 2 nm and 50 nm are called mesopores, and pores with widths not exceeding about 2 nm are called micropores (see Pure Appl. Chem., 2015, vol. 87, pp. 1051-1069). The micropore, mesopore, and total pore volume for the zeolites were calculated by measuring their nitrogen adsorption at a temperature of 77 K with an ASAP 2420 or 2425 instrument from Micromeretics. Prior to the adsorption measurements, 200-500 mg of calcined sample were held under vacuum at 400° C. for 16 hours to remove residual water and other volatile substances from the pores. The isotherm data were analyzed by Non-Linear Density Functional Theory (NLDFT) methods as part of the MicroActive software to determine micropore, mesopore, and total pore volumes (see Chem. Soc. Rev., 2017, vol. 46. pp. 389-414).

Certain as-received zeolites will be described in terms of “nanozeolite.” In an embodiment, a nanozeolite refers to a zeolite with a median crystallite size diameter below 1 micrometer for at least one of its crystal dimensions. In another embodiment, a nanozeolite refers to a zeolite with a median crystallite size diameter below 0.2 micrometers for at least one of its crystal dimensions. In yet another embodiment, a nanozeolite refers to a zeolite with a median crystallite size diameter below 0.1 micrometers for at least one of its crystal dimensions. This includes crystallites with anisotropic dimensions, such as needle-like or plate-like morphologies, where the median diameter for one or two of its crystal dimensions may exceed 1 micrometer. Such crystallites may aggregate into larger polycrystalline aggregates of particles, creating spaces within the aggregate that may exist as mesopores and/or macropores. The crystallite and/or polycrystalline aggregate size of a nanozeolite can be measured using numerous methods. Scanning electron microscopy (SEM) can be used to determine the structural and morphological information of zeolite particles. Methods and software have been developed to extract quantitatively the average crystallite and/or aggregate size and distribution from SEM images (see Nanoscale, 2020, vol. 12, pp. 19461). Particle size analyses may also be performed by other methods, such as electrical zone sensing, laser diffraction, light scattering, sedimentation, and the like. For example, laser diffraction measurements capture detailed information about particle size distribution by measuring the scattering intensity of particles as a function of the scattering angle, wavelength, and polarization of light based on applicable scattering models (see Geoderma, 2022, vol. 409, pp. 115627). The preparation of the zeolite sample, the instrument type, and measurement protocols determine whether the particle size distribution of the individual crystallite and/or aggregates are measured. One skilled in the art understands that a combination of data sets collected using different instruments and/or methods may be used to define the crystallite and aggregate particle size and distribution of nanozeolites.

Characterization of zeolites will be described in terms of their “loss on ignition” or “LOI” that describes the mass percentage of the solid that volatilizes when it is heated to 900° C. Other characterization of zeolites will be described in terms of their “silica to alumina” or “SiO₂/Al₂O₃” or “Si/Al₂” or “SAR” that describes the molar ratio between silica and alumina in the bulk solid. The bulk alumina and silica mass percentages along with the bulk mole silica to alumina (SiO₂/Al₂O₃) ratio for each sample was analyzed by X-ray fluorescence (XRF). A few grams of the zeolite powder were pressed into a pellet and analyzed with either an Axios Advanced WDXRF analyzer or Zetium WDXRF analyzer from Malvern PANalytical.

### Post-Synthesis Treatments to Add Mesoporosity to Zeolites

Certain zeolites will be described in terms of “mesoporized” that were treated by post-synthesis methods to increase their mesopore volume. In an embodiment, the zeolites mesoporized by post-synthesis treatment have an increased mesopore volume between the pore widths of 2 to 50 nm over the mesopore volume of parent zeolite between the pore widths of 2 to 50 nm before post-synthesis treatment. In still another embodiment, the zeolites mesoporized by post-synthesis treatment have an increased mesopore volume between the pore widths of 2 to 10 nm over the mesopore volume of parent zeolite between the pore widths of 2 to 10 nm before post-synthesis treatment. In still another embodiment, the zeolites mesoporized by post-synthesis treatment have an increased mesopore volume between the pore widths of 2 to 7 nm over the mesopore volume of parent zeolite between the pore widths of 2 to 7 nm before post-synthesis treatment.

Mesoporized zeolites can be prepared by post-synthesis treatment that disperses one or more zeolites in a heated aqueous caustic solution. One skilled in the art understands that the caustic source, solution pH, reaction temperature, order of reagent addition, and/or reaction times may vary. In one embodiment one or more alkali metal hydroxides, alkaline earth hydroxide, quaternary alkyl ammonium hydroxides, and alkali metal carbonates disclosed in U.S. Pat. No. 8,969,233 are used as the caustic source to mesoporize zeolites. One skilled in the art understands that the caustic solid or solution can be added at different rates to the aqueous slurry. In one embodiment, the caustic solid or solution is combined quickly with the zeolite, i.e., in one pour, as described in U.S. Pat. No. 3,326,797. In another embodiment, the caustic solid or solution is added gradually to mesoporize the zeolite as taught in U.S. Pat. No. 11,325,835.

One skilled in the art will also understand that certain post-synthesis treatments also use pore-directing agents and/or surfactants, where the amount used in the reaction may vary. Furthermore, one skilled in the art will understand that a wide variety of compounds can be used as pore directing agents and/or surfactants. In one embodiment, zeolites are mesoporized using a post-synthesis treatment comprising an aqueous mixture of caustic and surfactant at elevated temperatures as described in U.S. Pat. No. 8,007,663 and US20230191375. In one embodiment, the surfactant can be cationic, anionic, or neutral. In a better embodiment, the surfactant comprises a quaternary alkyl ammonium salt, such as cetyltrimethylammonium chloride (CTAC) or cetyltrimethylammonium bromide (CTAB). In another embodiment, zeolites are mesoporized using a post-synthesis treatment comprising an aqueous mixture of caustic and pore-directing agent, which are also referred to as protective agents, at elevated temperatures as disclosed in WO2024194193. In a better embodiment, the pore-directing agent comprises a tetraalkyl ammonium salt, such as tetramethyl ammonium bromide, tetraethyl ammonium bromide, tetrapropyl ammonium bromide, or tetrabutyl ammonium bromide, and so forth, or an alkylamine, such ethylamine, propylamine, butylamine, and so forth. In a different embodiment, inorganic additives, like metal salts, can be used as pore-directing or protective agents during aqueous caustic treatments to mesoporize zeolites as taught in US20230051097.

One skilled in the art understands that the post-synthesis treatment to mesoporize one or more zeolites may start when a variety of methods to combine the zeolite and caustic in an aqueous slurry are employed. In one embodiment, a caustic powder or caustic solution is added to an aqueous slurry of zeolites, which in certain preparations contains a pore-directing agent. In another embodiment, a zeolite powder or zeolite slurry is added to an aqueous solution of caustic, which in certain preparations contains a pore-directing agent. In a different embodiment, a zeolite is slurried with water, filtered to remove some of the water and yield a wet cake in the filtration funnel, which is then contacted with a caustic solution as taught in WO2024194193.

Certain mesoporized zeolites will be described in terms of “acid washed” or “acid treated” that treats the caustic-treated mesoporous zeolite with an acid solution. One skilled in the art understands that the acid source, solution pH, order of reagent addition, reaction temperature, and/or reaction times may vary. In one embodiment, one or more of the mineral acids or organic acids disclosed in U.S. Pat. No. 5,112,473 or WO2024194193 are used. The different embodiments described above for contacting a zeolite with caustic to form a heated aqueous slurry to mesoporize the zeolite can be applied to create a heated aqueous slurry of acid and zeolite to acid wash the zeolite.

One skilled in the art understands that the methods used to contain the slurries and agitate them may vary significantly. This applies to any step, including caustic treatment, acid treatment, or ion-exchange treatment. In an embodiment, the post-synthesis treatment of one or more zeolites is performed in a sealed Teflon bottle with the slurry being kept static in a heated oven. In a better embodiment, post-synthesis treatment of one or more zeolites is performed in a sealed Teflon bottle with the slurry being agitated by rotating the bottle, which is clamped to a moving mechanical belt, inside a heated rotary oven. In an even better embodiment, post-synthesis treatment of one or more zeolites is performed in sealed Teflon bottle containing at least one mixing ball with the slurry being agitated by rotating the bottle, which is clamped to a moving mechanical belt, inside a heated rotary oven. One skilled in the art understands that different types of open containers, such as beakers, round-bottomed flask, Erlenmeyer flask, and so forth, can be used to contain the slurry. In one embodiment, the post-synthesis treatment of one or more zeolites is performed in a container with the slurry being agitated by a magnetic Teflon stir bar being rotated on a magnetic stir plate. In a better embodiment, the post-synthesis treatment of one or more zeolites is performed in a container with the slurry being agitated by an overhead mixer rotating a stirring rod with a propeller.

One skilled in the art understands that the method to separate the mesoporized and/or acid treated zeolite from the aqueous portion of the slurry may vary. Known separation processes include gravity filtration, vacuum filtration, a filter press, and the use of centrifugation. One skilled in the art also understands there may be washing steps to remove residual caustic, surfactant, ions, and/or pore-directing agents from the mesoporized zeolite.

If desired, the mesoporized zeolite may be ion exchanged to reduce the amount of alkali cation. One skilled in the art understands that the ion exchange reagents, mass of reagents, order of reagent addition, ion exchange temperature, and/or ion exchange times may vary. In one embodiment, one or more ion exchanges of the mesoporized zeolite occurs after the calcination step to remove the residual organics. In a different embodiment, one or more ion exchanges of the mesoporized zeolite occurs before the calcination step to remove the residual organics.

If an organic surfactant and/or pore-directing agent are used, the mesoporized zeolite is calcined to remove them. One skilled in the art understands that the temperature, atmosphere, ramping and cooling rates, and type of furnace may vary. In one embodiment, the mesoporized zeolite is calcined after it has been separated from the aqueous portion of the slurry. In a better embodiment, the mesoporized zeolite is calcined after it has been separated from the aqueous portion of the slurry and washed significantly with water. In a different embodiment, the mesoporized zeolite is calcined after it has been ion exchanged to reduce its amount of alkali metal cation. In another embodiment, the mesoporized zeolite is calcined after a binder has been added as disclosed in US20230191375. In an even better embodiment, the mesoporized zeolite is calcined after a binder has been added and the blend of solids is shaped into a catalyst carrier as disclosed in US20230191375.

### Blend of Mesoporous Zeolites

The post-synthesis blend of mesoporous zeolites is prepared from a mixture having a mesoporous Y zeolite and a second mesoporous zeolite, a zeolite with a one-dimensional, 10-ring zeolite topology, such as ZSM-22, ZSM-23, or ZSM-48. In an embodiment, the mass ratio of the mesoporous Y zeolite in the blend is no more than 0.67, or no more than 0.50, or no more than 0.33, or no more than 0.20. In another embodiment, the mass ratio of the second mesoporous zeolite is at least 0.33, or at least 0.5, or at least 0.67, or at least 0.80.

In various embodiments, the process of the invention employs a blend of mesoporous zeolites. In such embodiments, at least a portion of the blend includes a catalyst composed of mesoporous Y zeolite. Preferably, the mesoporosity of the Y zeolite was added using a post-synthesis treatment using any of the methods described above. As described below, Y zeolites post-synthetically treated to add mesopores have a greater product yield and/or activity in hydroprocessing methods involving catalysts.

In various embodiments, another portion of the blend includes a catalyst composed of a mesoporous zeolite with a one-dimensional, 10-ring zeolite topology, such as ZSM-22, ZSM-23, or ZSM-48. In one embodiment, certain as-received one-dimensional, 10-ring zeolites may be mesoporous zeolites, owing to them being comprised of aggregates of crystallites. Preferably, the zeolite with a one-dimensional, 10-ring zeolite topology, such as ZSM-22, ZSM-23, or ZSM-48, was mesoporized using the above-mentioned caustic and/or acid post-synthesis treatments. As described below, one-dimensional, 10-ring zeolite topology, such as ZSM-22, ZSM-23, or ZSM-48, zeolites post-synthetically mesoporized have a greater product yield and/or activity in hydroprocessing methods involving catalysts.

In an even better embodiment, the blend of Y zeolite and a one-dimensional, 10-ring zeolite topology, like ZSM-22, ZSM-23, or ZSM-48, was mesoporized using the above-mentioned caustic and/or acid post-synthesis treatments of the blend. As described below, a blend of Y and zeolite with a one-dimensional, 10-ring zeolite topology, such as ZSM-22, ZSM-23, or ZSM-48, post-synthetically mesoporized, has a greater product yield and/or activity in hydroprocessing methods involving catalysts.

In an embodiment, post-synthesis treatments of a blend of zeolites may be performed on a slurry where the two or more zeolites were blended prior to the start of the treatment. The blend of zeolites can be added as a blended powder or a slurry of water and blend of zeolites. In other embodiments, post-synthesis treatments may be performed on a slurry of a single zeolite to begin the treatment, and the second zeolite is added to the slurry later to create the blend of zeolites. Each zeolite can be added as a powder or a slurry of water and zeolite. In an embodiment, the time difference between adding the first and second zeolite is at least 5 minutes, or at least 60 minutes, or at least 120 minutes, or at least 240 minutes. In an embodiment, the pH of the aqueous slurry is being monitored periodically to determine the hydroxide concentration of the solution and/or how much hydroxide has been consumed by the mesoporization reaction. In a better embodiment, the pH of the aqueous slurry is being monitored constantly to determine the hydroxide concentration of the solution and/or how much hydroxide has been consumed by the mesoporization reaction. In an even better embodiment, the pH and/or hydroxide consumption is being monitored to determine when to add the second zeolite and create the blend of zeolites being mesoporized together in the same slurry.

### Catalyst Formulation

Blends of mesoporous zeolite powders as part of a catalyst may also be used with a metal hydrogenation component. Metal hydrogenation components may be from Groups 6-12 of the Periodic Table based on the IUPAC system having Groups 1-18, preferably Groups 6 and 8-10. Examples of such metals include Ni, Mo, Co, W, Mn, Cu, Zn, Ru, Pt or Pd or mixtures thereof. The amount of hydrogenation metal or metals may range from 0.05 to 50 wt. %, based on the specific application.

In an embodiment, a method of preparing a catalyst composition comprises intimately mixing an unsupported metal oxide with an acid function. The unsupported metal oxide comprises Group 8-10 and Group 6 metals (and optionally Group 12 metals), such as Ni, Mo, Co, W, Cu, Zn, and Ru. The acid function comprises blending a first zeolite and a second zeolite together and mesoporizing or blending a mesoporized first zeolite (post-synthesis treatment leading to an increased mesopore volume between 2 and 10 nm) with either an as synthesized mesoporous second zeolite or a post-synthesis mesoporized second zeolite. The first zeolite comprises Y zeolite and the second zeolite comprises a one-dimensional, 10-ring zeolite. Intimate mixing may be obtained by sufficiently reducing the particle size of the components and may comprise techniques such as slurry/wet grinding, co-mulling, or mixing. During the forming step, additional additives may be included such as extrusion aids, burn out agents, peptizing agents, and the like, as known by those skilled in the art. The unsupported metal oxide may first be heat treated; heat treatment of 60 to 300° C. may be used, more preferably heat treatment of 100 to 150° C. Additionally, the acid function may optionally be first heat treated prior to being combined with said unsupported metal oxide. The heat treatment used for the acid function may be less than about 550° C., and in some cases up to 650° C., and may vary depending on the nature of the zeolite being used. After the intimately mixed catalyst is formed, the catalyst may be heat treated at 60 to 300° C. or, more preferably, from 100 to 150° C.

Another aspect of the invention features a method of making a formed support comprising an acid function consisting of a first zeolite and a second zeolite that were mesoporized together or a blend of a mesoporized first zeolite (post-synthesis treatment leading to an increased mesopore volume between 2 and 10 nm) with either an as synthesized mesoporous second zeolite or a post-synthesis mesoporized second zeolite, and optionally silica, alumina, magnesia, zirconium, silica-alumina, and mixtures thereof. A dilute acid, such as tartaric acid, HCl, HNO₃, KOH, and the like may be added to the mixture, or when alumina is added, to all or a fraction of the alumina portion of the mixture to form a homogeneous mixture. The homogeneous mixture is formed into a desired shape by forming means well known in the art. These forming means include extrusion, spray drying, oil dropping, pelletizing, and the like. Extrusion means include screw extruders and extrusion presses. The forming means will determine how much water, if any, is added to the mixture. The formed support can subsequently be heat treated at 450-700° C., or more preferably, from 500 to 650° C. The metal hydrogenation component(s) is incorporated in the catalytic composite in any suitable manner known to the art, such as by coprecipitation, coextrusion with the porous carrier material, or impregnation of the porous carrier material either before, after, or simultaneously with other metal hydrogenation components. For ease of operation, it is preferred to simultaneously incorporate the hydrogenation components together when multiple hydrogenation components are added. One method of depositing the hydrogenation component involves impregnating the support with a solution (preferably aqueous) of a decomposable compound(s), wherein decomposable means that upon heating, the compound is converted to an element or oxide with the release of byproducts. Illustrative of the decomposable compounds without limitation are complexes or compounds such as, nitrates, halides, sulfates, acetates, organic alkyls, hydroxides, and the like. Conditions for decomposition include temperatures ranging from about 150° C. to about 550° C. When multiple hydrogenation components are added, the first component can be impregnated onto the carrier either prior to, simultaneously with, or after the other hydrogenation components, although not necessarily with equivalent results. If a sequential technique is used, the composite can be dried, or dried and calcined, in between impregnations. The hydrogenation component(s) include one or more of the following Group 8-10 metals, Group 6 metals, Group 12 metals such as Ni, Mo, Co, W, Mn, Cu, Zn, Ru, Pt or Pd or mixtures thereof.

In another embodiment, the invention involves a process comprising introducing a feedstock to a hydroprocessing/hydroisomerization reaction zone at hydroprocessing/hydroisomerization reaction conditions in the presence of a hydroprocessing/hydroisomerization catalyst comprising a metal selected from Group 8-10 metals, Group 6 metals, Group 12 metals or mixtures thereof such as Ni, Mo, Co, W, Mn, Cu, Zn, Ru, Pt or Pd or mixtures thereof and an acid function comprising: mesoporizing a first zeolite and blending the mesoporized first zeolite with an as-synthesized mesoporous second zeolite; or mesoporizing a first zeolite, mesoporizing a second zeolite, and blending the mesoporized first zeolite with the mesoporized second zeolite; or blending a first zeolite and a second zeolite, and mesoporizing the blend of the first zeolite and the second zeolite; wherein the first zeolite comprises Y zeolite, and the second zeolite comprises a one-dimensional, 10-ring zeolite. The feedstock may be selected from any suitable feedstock, including, but not limited to, vacuum gas oil, kerosene, jet fuel, distillate, light cycle oil, naphtha, deasphalted oil, atmospheric gas oil, coker gas oil, Fisher Tropsch wax, Fisher Tropsch oil, lube base oil, biogenic materials, waste fats, oils, and greases or feedstocks such as oil crops, and mixtures thereof.

In a specific embodiment, a catalyst as described herein may be used in first-stage distillate hydrocracking of vacuum gas oil wherein at least one bed in the hydrocracking reaction zone would contain the catalyst described in this invention. The primary acid function in the catalyst comprises: mesoporizing a first zeolite and blending the mesoporized first zeolite with an as-synthesized mesoporous second zeolite; or mesoporizing a first zeolite, mesoporizing a second zeolite, and blending the mesoporized first zeolite with the mesoporized second zeolite; or blending a first zeolite and a second zeolite, and mesoporizing the blend of the first zeolite and the second zeolite; wherein the first zeolite comprises Y zeolite, and the second zeolite comprises a one-dimensional, 10-ring zeolite in concentrations from about 0.5 to 70 wt % of the hydrocracking catalyst. The Group 8-10 metal ranges from about 2 to 25 wt % of the hydroprocessing catalyst and said Group 6 metal ranges from about 5 to 55 wt % of the hydroprocessing catalyst. When included, the Group 12 component ranges from about 0 to 5 wt % of the hydroprocessing catalyst. The mesoporized zeolite containing catalyst described herein results in significantly improved activity and yield.

In another embodiment, a catalyst as described herein may be used in the conversion of Fisher Tropsch wax to sustainable aviation fuel. The primary acid function in the catalyst comprises: mesoporizing a first zeolite and blending the mesoporized first zeolite with an as-synthesized mesoporous second zeolite; or mesoporizing a first zeolite, mesoporizing a second zeolite, and blending the mesoporized first zeolite with the mesoporized second zeolite; or blending a first zeolite and a second zeolite, and mesoporizing the blend of the first zeolite and the second zeolite; wherein the first zeolite comprises Y zeolite, and the second zeolite comprises a one-dimensional, 10-ring zeolite. The Group 8-10 metal(s) ranges from about 0.05 to 50 wt % of the catalyst.

In order to more fully illustrate the instant invention, the following examples are set forth. It is to be understood that the examples are only by way of illustration and are not intended as an undue limitation on the broad scope of the invention as set forth in the appended claims.

### EXAMPLES

### Example 1

Numerous as-received zeolites from commercial suppliers were characterized to establish their initial LOI, SiO₂/Al₂O₃, and porosity. The Y zeolites were received from Zeolyst. Different one-dimensional, 10-ring zeolites were received from Nankai and Pacific Industrial Development Corporation (PIDC). The as-received zeolites were submitted for characterization and their measured properties are summarized in Table 1.

TABLE 1
Overview of parent zeolite properties

| | | SiO₂/Al₂O₃ | LOI | Pore Volume (cc/g) | | |
|---|---|---|---|---|---|---|
| Zeolite Type | Supplier | (SAR) | (mass %) | V_{micro} | Vₘₑₛₒ | Vₜₒₜₐₗ |
| Y (CBV 760) | Zeolyst | 52 | 12.5 | 0.38 | 0.16 | 0.54 |
| Y (CBV 780) | Zeolyst | 88 | 18.5 | 0.34 | 0.18 | 0.52 |
| ZSM-22 | Nankai | 46 | 4.6 | 0.11 | 0.07 | 0.18 |
| ZSM-23 | Nankai | 38 | 5.2 | 0.07 | 0.25 | 0.32 |
| ZSM-48 | Nankai | 111 | 3.5 | 0.09 | 0.11 | 0.20 |
| ZSM-48 | PIDC | 61 | 8.5 | 0.11 | 0.49 | 0.60 |
| ZSM-48 | PIDC | 80 | 5.8 | 0.08 | 0.26 | 0.34 |

### Examples 2-8

Certain as-received zeolites were mesoporized using a post-synthesis treatment in which they were mixed in a heated aqueous solution with sodium hydroxide and a cetyltrimethylammonium salt, i.e., cetyltrimethylammonium bromide or cetyltrimethylammonium chloride, for at least 4 hours.

20 grams of as-received CBV 760 were added to a 1-liter Teflon bottle followed by 150 grams of deionized water to create a slurry. 48 grams of cetyltrimethylammonium chloride solution (25 wt. % in water) was added to the bottle. A ceramic ball was added to the Teflon bottle, and the bottle was capped. The Teflon bottle was agitated by clamping the bottle to a moving mechanical belt inside a rotary oven. The mechanical belt was set to operate at a speed of 15-20 RPM and the oven began heating to 60° C. A caustic solution was made by dissolving 1.6 grams of sodium hydroxide in 2 grams of deionized water. The caustic solution was added to the slurry in the Teflon bottle once the slurry reached 60° C. The bottle was resealed, clamped back onto the belt, and tumbled for 4 hours. After four hours, the slurry was quenched in an ice bath to cool below 20° C. The product was isolated by centrifuging at 10,000 RPM for 10 minutes. The supernatant was poured off, and the wet cake was re-slurried with deionized water. The pH of the slurry was adjusted to pH of about 8 using a dilute nitric acid solution. The acid-washed slurry was vacuum filtered until a wet cake formed, and the wet cake was washed with about 1 liter of 65° C. deionized water. After washing, the wet cake was allowed to rest at room temperature to facilitate evaporation of residual surface water.

The zeolite cake was acid treated by placing it in a 500-mL borosilicate glass beaker with 200 grams of deionized water and stirring at 400 RPM. The solution was heated to 70° C. Once the slurry reached 70° C., 3.05 g of concentrated nitric acid (15.8 Normal) was added, and the slurry was stirred for 1 hour. The solid product was then vacuum filtered and washed several times with 500-mL of deionized water. The product was dried at 100° C. for 16 hours in a drying oven.

The product was calcined in air at 550° C. for 6 hours to remove the organic components. The material was ammonium exchanged to reduce its sodium content. 14 grams of the mesoporous product was placed in a 500-mL glass beaker containing 140 grams of deionized water and 14 grams of ammonium nitrate and heated to 75° C. for 2 hours. The solid product was vacuum filtered and washed with 500-mL of 65° C. deionized water several times. The material was dried at 100° C. for 16 hours in a drying oven.

TABLE 2
Overview of properties of mesoporized zeolites

| | | SiO₂/Al₂O₃ | LOI | Pore Volume (cc/g) | | |
|---|---|---|---|---|---|---|
| Example | Zeolite | (SAR) | (mass %) | V_{micro} | Vₘₑₛₒ | Vₜₒₜₐₗ |
| 2 | Y | 63 | 7.5 | 0.34 | 0.40 | 0.74 |
| | (CBV 760) | | | | | |
| 3 | Y | 83 | 6.7 | 0.29 | 0.54 | 0.84 |
| | (CBV 780) | | | | | |
| 4 | ZSM-22 | 52 | 6.4 | 0.11 | 0.12 | 0.23 |
| 5 | ZSM-23 | | | | | |
| 6 | ZSM-48 | 115 | 7.3 | 0.10 | 0.16 | 0.26 |
| | (Nankai) | | | | | |
| 7 | ZSM-48 | 65 | 6.4 | 0.13 | 0.54 | 0.70 |
| | (PIDC-60) | | | | | |
| 8 | ZSM-48 | | | | | |
| | PIDC-80) | | | | | |

### Example 9

In a 1-liter Teflon bottle, a blend of 67% Y and 33% ZSM-48 was prepared by combining 15.31 grams of CBV-760 from Zeolyst (12.5% LOI) and 6.89 grams of ZSM-48 from Nankai (3.5% LOI), followed by adding 155 grams of deionized water. 48 grams of cetyltrimethylammonium chloride solution (25 wt. % in water) was added to the bottle. A ceramic ball was added to the Teflon bottle, and the bottle was capped. The Teflon bottle was agitated by clamping the bottle to a moving mechanical belt inside a rotary oven. The mechanical belt was set to operate at a speed of 15-20 RPM and the oven began heating to 60° C. A caustic solution was made by dissolving 3.2 grams of sodium hydroxide in 4 grams of deionized water. The caustic solution was added to the slurry in the Teflon bottle once the slurry reached 60° C. The bottle was resealed, clamped back onto the belt, and tumbled for 4 hours. After four hours, the slurry was quenched in an ice bath to cool below 20° C. The product was isolated by centrifuging at 10,000 RPM for 10 minutes. The supernatant was poured off, and the wet cake was re-slurried with deionized water. The pH of the slurry was adjusted to pH˜8 using a dilute nitric acid solution. The acid-washed slurry was vacuum filtered until a wet cake formed, and the wet cake was washed with about 1 liter of 65° C. deionized water. After washing, the wet cake was allowed to rest at room temperature to facilitate evaporation of residual surface water.

The zeolite cake was acid treated by placing it in a 500-mL borosilicate glass beaker with 200 grams of deionized water and stirring at 400 RPM. The solution was heated to 70° C. Once the slurry reached 70° C., 3.05 g of concentrated nitric acid (15.8 Normal) was added, and the slurry was stirred for 1 hour. The solid product was vacuum filtered and washed several times with 500-mL of deionized water. The material was dried at 100° C. for 16 hours in a drying oven.

The material was calcined in air at 550° C. for 6 hours to remove the organic components. The material was ammonium exchanged to reduce the sodium content. 14 grams of the mesoporous product was placed in a 500-mL glass beaker containing 140 grams of deionized water and 14 grams of ammonium nitrate and heated to 75° C. for 2 hours. The solid product was vacuum filtered and washed with 500-mL of 65° C. deionized water several times. The material was dried at 100° C. for 16 hours in a drying oven.

### Example 10

In a 1-liter Teflon bottle, a blend of 33% Y (6.6 grams of CBV-760 from Zeolyst) and 67% ZSM-48 (13.89 grams of ZSM-48 from Nankai) was added to the bottle, followed by 155 grams of deionized water. The 33% Y and 67% ZSM-48 zeolite blend was post-synthetically modified and worked up as described in Example 9.

### Example 11

In a 1-liter Teflon bottle, a blend of 50% Y (11.42 grams of CBV-760 from Zeolyst) and 50% ZSM-48 (10.6 grams of PIDC-80 from Pacific Industrial Development Corporation) was added to the bottle, followed by 155 grams of deionized water. The 50% Y and 50% ZSM-48 zeolite blend was post-synthetically mesoporized and worked up as described in Example 9.

### Example 12

In a 1-liter Teflon bottle a blend of 50% Y (11.42 grams of CBV-760 from Zeolyst) and 50% ZSM-48 (10.6 grams of PIDC-60 from Pacific Industrial Development Corporation) was added to the bottle, followed by 155 grams of deionized water. The 50% Y and 50% ZSM-48 zeolite blend was post-synthetically mesoporized and worked up as described in Example 9.

### Example 13

In a 1-liter Teflon bottle, 14.64 grams of PIDC-60 from Pacific Industrial Development Corporation was added to 155 grams of deionized water. Next, 48 grams of cetyltrimethylammonium chloride solution (25 wt. % in water) was added to the bottle. A ceramic ball was added to the Teflon bottle, and the bottle was capped. The Teflon bottle was agitated by clamping the bottle to a moving mechanical belt inside a rotary oven. The mechanical belt was set to operate at a speed of 15-20 RPM and the oven began heating to 60° C. A caustic solution was made by dissolving 3.2 grams of sodium hydroxide in 4 grams of deionized water. The caustic solution was added to the slurry in the Teflon bottle once the slurry reached 60° C. The bottle was resealed, clamped back onto the belt, and tumbled for 2 hours. After 2 hours, the Teflon bottle was removed from the oven and 7.54 grams of CBV-760 from Zeolyst was added to the slurry in the bottle to create a 33% Y and 67% ZSM-48 blend of zeolites. The bottle was resealed, clamped back onto the rotating belt, and the slurry mixture was reacted for 2 more hours at 60° C. After four hours total reaction time, the slurry was quenched in an ice bath to cool below 20° C. The product was isolated by centrifuging at 10,000 RPM for 10 minutes. The supernatant was poured off, and the wet cake was re-slurried with deionized water. The pH of the slurry was adjusted to pH of about 8 using a dilute nitric acid solution. The acid-washed slurry was vacuum filtered until a wet cake formed, and the wet cake was washed with about 1 liter of 65° C. deionized water. After washing, the wet cake was allowed to rest at room temperature to facilitate evaporation of residual surface water.

The zeolite cake was acid treated by placing it in a 500-mL borosilicate glass beaker with 200 grams of deionized water and stirring at 400 RPM. The solution was heated to 70° C. Once the slurry reached 70° C., 3.05 g of nitric acid was added, and the slurry was stirred for 1 hour. The solid product was vacuum filtered and washed several times with 500-mL of deionized water. The material was dried at 100° C. for 16 hours in a drying oven.

The material was calcined in air at 550° C. for 6 hours to remove the organic components. The material was ammonium exchange to reduce the sodium content. 14 grams of the mesoporous product was placed in a 500-mL glass beaker containing 140 grams of deionized water and 14 grams of ammonium nitrate and heated to 75° C. for 2 hours. The solid product was vacuum filtered and washed with 500-mL of 65° C. deionized water several times. The material was dried at 100° C. for 16 hours in a drying oven.

### Example 14

In a 1-liter Teflon bottle, a blend of 50% Y and 50% ZSM-48 was prepared by combining 11.42 grams of CBV-760 from Zeolyst (12.5% LOI) and 10.93 grams of PIDC-60 from Pacific Industrial Development Corporation (8.5% LOI), followed by adding 155 grams of deionized water. 48 grams of cetyltrimethylammonium chloride solution (25 wt. % in water) was added to the bottle. A ceramic ball was added to the bottle, and the bottle was capped. The Teflon bottle was agitated by clamping the bottle to a moving mechanical belt inside a rotary oven. The mechanical belt was set to operate at a speed of 15-20 RPM and the oven began heating to 60° C. A caustic solution was made by dissolving 1.6 grams of sodium hydroxide in 2 grams of deionized water. The caustic solution was added to the slurry in the Teflon bottle once the slurry reached 60° C. The bottle was resealed, clamped back onto the belt, and tumbled for 2 hours. After four hours, the slurry was quenched in an ice bath to cool below 20° C. The product was isolated by centrifuging at 10,000 RPM for 10 minutes. The supernatant was poured off, and the wet cake was re-slurried with deionized water. The pH of the slurry was adjusted to pH of about 8 using a dilute nitric acid solution. The acid-washed slurry was vacuum filtered until a wet cake formed, and the wet cake was washed with about 1 liter of 65° C. deionized water. After washing, the wet cake was allowed to rest at room temperature to facilitate evaporation of residual surface water.

The zeolite cake was acid treated by placing it in a 500-mL borosilicate glass beaker with 200 grams of deionized water and stirring at 400 RPM. The solution was heated to 70° C. Once the slurry reached 70° C., 3.05 g of nitric acid was added, and the slurry was stirred for 1 hour. The solid product was vacuum filtered and washed several times with 500-mL of deionized water. The material was dried at 100° C. for 16 hours in a drying oven.

The material was calcined in air at 550° C. for 6 hours to remove the organic components. The material was ammonium exchanged to reduce the sodium content. 14 grams of the mesoporous product was placed in a 500-mL glass beaker containing 140 grams of deionized water and 14 grams of ammonium nitrate and heated to 75° C. for 2 hours. The solid product was vacuum filtered and washed with 500-mL of 65° C. deionized water several times. The material was dried at 100° C. for 16 hours in a drying oven.

### Example 15

In a 1-liter Teflon bottle, a blend of 50% Y (11.5 grams of CBV-760 from Zeolyst) and 50% ZSM-48 (10.5 grams of ZSM-48 from Nankai) was added to the bottle, followed by 155 grams of deionized water. The 50% Y and 50% ZSM-48 zeolite blend was post-synthetically modified and worked up as described in Example 14.

### Example 16

In a 1-liter Teflon bottle, a blend of 33% Y (7.21 grams of CBV-760 from Zeolyst) and 67% ZSM-48 (15.31 grams of PIDC-60 from Pacific Industrial Development Corporation) was added to the bottle, followed by 155 grams of deionized water. The 33% Y and 67% ZSM-48 zeolite blend was post-synthetically modified and worked up as described in Example 14, except 3.2 grams of sodium hydroxide was added to the aqueous reaction mixture.

### Example 17

In a 1-liter Teflon bottle, a blend of 33% Y (7.71 grams of CBV-780 from Zeolyst) and 67% ZSM-48 (14.64 grams of PIDC-60 from Pacific Industrial Development Corporation) was added to the bottle, followed by 155 grams of deionized water. The 33% Y and 67% ZSM-48 zeolite blend was post-synthetically modified and worked up as described in Example 14.

### Example 18

In a 1-liter Teflon bottle, a blend of 33% Y and 67% ZSM-48 was prepared by combining 7.21 grams of CBV-760 from Zeolyst (12.5% LOI) and 15.31 grams of PIDC-60 from Pacific Industrial Development Corporation (8.5% LOI), followed by 600 grams of deionized water. 32 grams of tetrapropylammonium bromide powder was added to the bottle. A ceramic ball was added to the bottle, and the bottle was capped. The Teflon bottle was agitated by clamping the bottle to a moving mechanical belt inside a rotary oven. The mechanical belt was set to operate at a speed of 15-20 RPM and the oven began heating to 65° C. A caustic solution was made by dissolving 4.8 grams of sodium hydroxide in 6 grams of deionized water. The caustic solution was added to the slurry in the Teflon bottle once the slurry reached 65° C. The bottle was resealed, clamped back onto the belt, and tumbled for 0.5 hours. After 30 minutes, the slurry was quenched in an ice bath to cool below 20° C. The product was isolated by centrifuging at 10,000 RPM for 10 minutes. The supernatant was poured off, and the wet cake was re-slurried with deionized water. The pH of the slurry was adjusted to pH of about 8 using a dilute nitric acid solution. The acid-washed slurry was vacuum filtered until a wet cake formed, and the wet cake was washed with about 1 liter of 65° C. deionized water. After washing, the wet cake was allowed to rest at room temperature to facilitate evaporation of residual surface water.

The zeolite cake was acid treated by placing it in a 500-mL borosilicate glass beaker with 200 grams of deionized water and stirring at 400 RPM. The solution was heated to 70° C. Once the slurry reached 70° C., 3.05 g of nitric acid was added, and the slurry was stirred for 1 hour. The solid product was vacuum filtered and washed several times with 500-mL of deionized water. The material was dried at 100° C. for 16 hours in a drying oven.

The material was calcined in air at 550° C. for 6 hours to remove the organic components. The material was ammonium exchanged to reduce the sodium content. 14 grams of the mesoporous product was placed in a 500-mL glass beaker containing 140 grams of deionized water and 14 grams of ammonium nitrate and heated to 75° C. for 2 hours. The solid product was vacuum filtered and washed with 500-mL of 65° C. deionized water several times. The material was dried at 100° C. for 16 hours in a drying oven.

### Example 19

In a 500-mL borosilicate glass beaker, a blend of 20% Y and 80% ZSM-48 was prepared by combining 4.57 grams of CBV-760 from Zeolyst (12.5% LOI) and 17.49 grams of PIDC-60 from Pacific Industrial Development Corporation (8.5% LOI), followed by adding 155 grams of deionized water. The slurry was stirred using a magnetic Teflon coated stir bar at a sufficient speed to prevent any zeolite settling at the bottom of the beaker. 48 grams of cetyltrimethylammonium chloride solution (25 wt. % in water) was added to the beaker under stirring and heated to 60° C. A caustic solution was made by dissolving 2.74 grams of sodium hydroxide in 4 grams of deionized water. The caustic solution was added to the slurry in the beaker once the slurry reached 60° C., and the slurry was stirred for 4 hours. After four hours, the slurry was quenched in an ice bath to cool below 20° C. The slurry was vacuum filtered and washed with 500 mL of deionized water. A solution of 50 mL deionized water and 2.05 grams of nitric acid was poured over the filter and washed again with 500 mL of deionized water. After washing, the wet cake was allowed to rest at room temperature to facilitate evaporation of residual surface water.

The zeolite cake was acid treated by placing it in a 500-mL borosilicate glass beaker with 200 grams of deionized water and stirring at 400 RPM. The solution was heated to 70° C. Once the slurry reached 70° C., 3.05 g of nitric acid was added, and the slurry was stirred for 1 hour. The solid product was vacuum filtered and washed several times with 500-mL of deionized water. The material was dried at 100° C. for 16 hours in a drying oven.

The material was calcined in air at 550° C. for 6 hours to remove the organic components. The material was ammonium exchanged to reduce the sodium content. 10 grams of the mesoporous product was placed in a 500-mL glass beaker containing 100 grams of deionized water and 10 grams of ammonium nitrate and heated to 75° C. for 2 hours. The solid product was vacuum filtered and washed with 500-mL of 65° C. deionized water several times. The material was dried at 100° C. for 16 hours in a drying oven.

### Example 20

In a 1-liter Teflon bottle, a blend of 50% Y (11.25 grams of CBV-760 from Zeolyst) and 50% ZSM-23 (10.52 grams of ZSM-23 from Nankai) was added to the bottle, followed by 155 grams of deionized water. The 50% Y and 50% ZSM-23 zeolite blend was post-synthetically modified and worked up as described in Example 9.

### Example 21

In a 1-liter Teflon bottle a blend of 50% Y (11.25 grams of CBV-760 from Zeolyst) and 50% ZSM-23 (10.46 grams of ZSM-22 from Nankai) was added to the bottle, followed by 155 grams of deionized water. The 50% Y and 50% ZSM-22 zeolite blend was post-synthetically modified and worked up as described in Example 9.

### Example 22

Examples 9-21 were submitted for characterization by numerous analytical methods to understand the impact of the post-synthesis mesoporization treatments on the pore volumes of the samples. Tables 3 and 4 illustrate that the mesoporized zeolite blends retain a significant amount of their micropore volumes after post-synthesis treatment. The mesoporization post-synthesis treatments also increases the mesopore volumes of the blend of zeolites.

TABLE 3
Overview of Mesoporized Blends of Y and ZSM-48 Zeolites

| | | | | Bulk | | | |
|---|---|---|---|---|---|---|---|
| | Zeolite | | Y:ZSM- | SiO₂/ | Pore Volume (cc/g) | | |
| Ex | Y | ZSM-48 | 48 Ratio | Al₂O₃ | V_{micro} | Vₘₑₛₒ | Vₜₒₜₐₗ |
| 9 | CBV-760 | Nankai | 67:33 | 60 | 0.22 | 0.52 | 0.75 |
| 10 | CBV-760 | Nankai | 33:67 | 80 | 0.16 | 0.36 | 0.51 |
| 11 | CBV-760 | PIDC 80 | 50:50 | 65 | 0.19 | 0.55 | 0.74 |
| 12 | CBV-760 | PIDC-60 | 50:50 | 56 | 0.20 | 0.64 | 0.84 |
| 13 | CBV-760 | PIDC-60 | 33:67 | 54 | 0.17 | 0.60 | 0.77 |
| 14 | CBV-760 | PIDC-60 | 50:50 | 55 | 0.21 | 0.44 | 0.64 |
| 15 | CBV-760 | Nankai | 50:50 | 73 | 0.19 | 0.32 | 0.50 |
| 16 | CBV-760 | PIDC-60 | 33:67 | 59 | 0.16 | 0.60 | 0.76 |
| 17 | CBV-780 | PIDC-60 | 33:67 | 66 | 0.17 | 0.47 | 0.64 |
| 18 | CBV-760 | PIDC-60 | 33:67 | 39 | 0.14 | 0.66 | 0.81 |
| 19 | CBV-760 | PIDC-60 | 20:80 | 73 | | | |

TABLE 4
Overview of Mesoporized Blends of Y and 1D/10R Zeolites

| | Zeolite | | Y:1D/10R | Bulk | Pore Volume (cc/g) | | |
|---|---|---|---|---|---|---|---|
| Ex | Y | 1D/10R | Ratio | SiO₂/Al₂O₃ | V_{micro} | Vₘₑₛₒ | Vₜₒₜₐₗ |
| 20 | CBV-760 | ZSM-23 | 33:67 | 44 | 0.15 | 0.58 | 0.73 |
| 21 | CBV-760 | ZSM-22 | 33:67 | 49 | 0.18 | 0.43 | 0.62 |

### Example 23

Each as-received or mesoporized single zeolite was ground in an agate mortar and pestle to remove any large chucks prior to model feed testing. The zeolite powder was pressed into a 3 cm diameter pellet by using a hydraulic pellet press and die where 5-8 metric tons of pressure were applied. The pressed zeolite pellet was then gently broken apart using a mortar and pestle. The resulting zeolite powder was meshed to a uniform particle size distribution using a screen with a 40/60 mesh size.

Certain blends of two zeolites were prepared by weighing the appropriate amount of each zeolite on a mass balance to achieve the desired ratio. The mass of each zeolite was adjusted to account for its LOI mass percentage. For example, a blend of 50% ZSM-48 and 50% Y zeolite was prepared by combining 0.53 g of PIDC-60 (LOI=8.5%) and 0.57 g of CBV 760 (LOI=12.5%).

The two zeolite powders were first blended together, and the blend was ground in an agate mortar and pestle to remove any large chunks prior to model feed testing. The blend of zeolite powders was pressed into a 3 cm diameter pellet by using a hydraulic pellet press and die where 5-8 metric tons of pressure were applied. The pressed zeolite pellet was then gently broken apart using a mortar and pestle. The resulting blend of zeolites was meshed to a uniform particle size distribution using a screen with a 40/60 mesh size.

### Example 24

Prior to model feed testing, the ammonium-exchanged zeolites that were mesoporized in Examples 2-21 were activated by placing them in a furnace, ramping the temperature up to 400° C., and holding the temperature at 400° C. for 5 hours under an air atmosphere flowing at 50 standard cubic feet per hour. The furnace was allowed to cool to room temperature naturally. The activation process decomposes the ammonium cation in the zeolite through the elimination of ammonia, yielding an H-form zeolite containing hydronium cations.

### Model Feed Testing

Model feed testing was conducted by evaluating gas-phase n-heptane conversion at slightly above atmospheric pressure. Catalysts were prepared as described in example 23. When two zeolites are indicated, the targeted volatile free ratios of each parent zeolite were weighed out (listed percent compositions are in weight percent), physically mixed to a fine powder, pelletized, and sized. A total of 230 mg of volatile free catalyst was loaded into each reactor. The sample was pretreated 550 C in 250 cc/min hydrogen for 50 min and tested in 125 cc/min (H₂:n-heptane=67); temperatures from 450 to 600° C. were scanned.

### Example 25

Catalyst AA was prepared with 33:67 Y:ZSM-48; it is used as the base case for comparison for n-heptane cracking model feed results. Catalyst EE was prepared using the same 33:67 Y:ZSM-48 ratio, but it was prepared using co-mesoporization. Compared to AA, EE exhibited 3.2% greater C₃+C₄ selectivity with only 5.9° C. lower activity. Catalyst BB was prepared using 50:50 Y:ZSM-48 using as received zeolites. Catalyst CC was prepared using the same 50:50 Y:ZSM-48 ratio, but it was prepared using co-mesoporization. Compared to BB, CC exhibited 1% greater C₃+C₄ selectivity with 11.6° C. lower activity. Catalyst DD was prepared using 67:33 Y:ZSM-48; although the activity was lower than that observed for Catalyst AA and Catalyst BB, it exhibited 1.4% higher selectivity than Catalyst BB and 2.8% higher selectivity than catalyst AA.

TABLE 5
n-heptane cracking data

| | | | C₃ + C₄ selectivity | |
|---|---|---|---|---|
| | | | (%) at 50% n- | Temperature (deg C.) |
| | | | heptane conversion | at 50% n-heptane |
| | | | relative to the base | conversion relative |
| | | | case (+ = more | to the base case (+ = |
| | | Ratio | selective, − = | more active, − = |
| Catalyst | Description | (wt %) | less selective) | less active) |
| Catalyst AA | Y zeolite (SAR 52) | 33:67 | Base | Base |
| | (33 wt %) and Nankai | | | |
| | MRE (SAR 111) | | | |
| | (67 wt %) (example 1, | | | |
| | example 23) | | | |
| Catalyst BB | Y zeolite (SAR 52) | 50:50 | 1.4 | 6.4 |
| | (50 wt %) and Nankai | | | |
| | MRE (SAR 111) | | | |
| | (50 wt %) (example 1, | | | |
| | example 23) | | | |
| Catalyst CC | Co-mesoporized Y and | 50:50 | 2.4 | −5.2 |
| | ZSM-48 (example | | | |
| | 15 and 24) | | | |
| Catalyst DD | Co-mesoporized Y and | 67:33 | 2.8 | −12.4 |
| | ZSM-48 (example | | | |
| | 9 and 24) | | | |
| Catalyst EE | Co-mesoporized Y and | 33:67 | 3.2 | −5.9 |
| | ZSM-48 (example | | | |
| | 10 and 24) | | | |

### Catalyst Preparation

Catalysts with an intimate interaction between the metal and acid functions were prepared using methods described in U.S. Pat. No. 11,826,738 example 3. After the appropriate particle size reduction, the wt % zeolite(s) noted in Table 6 were formed with the noted amount of unsupported metal oxide

TABLE 6
Description of catalyst formulations

| | wt % | | | | | |
|---|---|---|---|---|---|---|
| | metal | | wt % | | wt % | |
| ID | oxide | Zeolite 1 | Zeolite 1 | Zeolite 2 | Zeolite 2 | Details |
| Catalyst A | 94.7 | Y, 52 SAR | 5.3 | N/A | 0.0 | — |
| | | (example 1) | | | | |
| Catalyst B | 89.9 | Y, 52 SAR | 3.3 | ZSM-48, | 6.8 | — |
| | | (example 1) | | 61SAR | | |
| | | | | (example 1) | | |
| Catalyst C | 94.7 | meso Y | 5.3 | N/A | 0.0 | — |
| | | (example 2) | | | | |
| Catalyst D | 81.7 | ZSM-48, | 18.3 | N/A | 0.0 | — |
| | | 61SAR | | | | |
| | | (example 1) | | | | |
| Catalyst E | 81.7 | meso ZSM- | 18.3 | N/A | 0.0 | — |
| | | 48 (example | | | | |
| | | 7) | | | | |
| Catalyst F | 91.8 | co-meso | 8.2 | N/A | 0.0 | — |
| | | Y + ZSM-48 | | | | |
| | | (example | | | | |
| | | 14) | | | | |
| Catalyst G | 91.8 | Y, 52 SAR | 4.1 | ZSM-48, | 4.1 | — |
| | | (example 1) | | 61SAR | | |
| | | | | (example 1) | | |
| Catalyst H | 91.8 | meso Y | 4.1 | meso ZSM-48 | 4.1 | — |
| | | (example 2) | | (example 7) | | |
| Catalyst I | 89.9 | Y, 52 SAR | 3.3 | ZSM-48, | 6.8 | — |
| | | (example 1) | | 61SAR | | |
| | | | | (example 1) | | |
| Catalyst J | 89.9 | meso Y | 3.3 | ZSM-48, | 6.8 | — |
| | | (example 2) | | 61SAR | | |
| | | | | (example 1) | | |
| Catalyst K | 89.9 | meso Y | 3.3 | ZSM-48, | 6.8 | Stacked 33% |
| | | (example 2) | | 61SAR | | Catalyst C on |
| | | | | (example 1) | | 67% Catalyst D |
| Catalyst L | 89.9 | meso Y | 3.3 | ZSM-48, | 6.8 | Mixed Particles |
| | | (example 2) | | 61SAR | | 33% Catalyst C |
| | | | | (example 1) | | and 67% |
| | | | | | | Catalyst D |
| Catalyst M | 92.5 | meso ZSM- | 7.5 | N/A | 0.0 | — |
| | | 48 (example | | | | |
| | | 15) | | | | |
| Catalyst N | 86.0 | ZSM-48 | 14.0 | N/A | 0.0 | — |
| | | 111 SAR | | | | |
| | | (example 1) | | | | |
| Catalyst O | 81.7 | ZSM-23 38 | 18.3 | N/A | 0.0 | — |
| | | SAR | | | | |
| | | (example 1) | | | | |
| Catalyst P | 91.8 | Y, 52 SAR | 4.1 | ZSM-23 38 | 4.1 | — |
| | | (example 1) | | SAR | | |
| | | | | (example 1) | | |
| Catalyst Q | 91.8 | co-meso | 8.2 | N/A | 0.0 | — |
| | | Y + ZSM-23 | | | | |
| | | (example | | | | |
| | | 20) | | | | |

### VGO Testing

For examples 26 to 30 catalysts were loaded such that the mass of metal oxide in each reactor was held constant. The zeolite loading was adjusted to target a similar activity range. Catalyst evaluation was completed in a hydrotreated VGO; feed details are included below in Table 7.

TABLE 7
Details of the hydrotreated VGO feed
Sweet, Hydrotreated VGO

| | |
|---|---|
| 628 | wppm S |
| 20 | wppm N |

Doped, Hydrotreated VGO

| | |
|---|---|
| 580 | Nitrogen (wppm) |
| 2.336 | Sulfur (wt %) |
| 28.7 | API |
| 0.88 | Relative Density @ 60° F. (15.56° C.) |
| 1.6 | Cutpoint at 149.0 Celsius |
| 2.9 | Cutpoint at 193.0 Celsius |
| 4.2 | Cutpoint at 216.0 Celsius |
| 9.6 | Cutpoint at 288.0 Celsius |
| 24.1 | Cutpoint at 371.0 Celsius |

Catalysts were liquid-sulfided in-situ using standard methods, inducted at 2000 psig at 362.8-371.1° C. (685° F.-700° F.), with 1.9 times the flowrate used during screening, 9,800 scf H₂/bbl for 12 hrs in the VGO feed. Testing was conducted at 2000 psig, 1.68 to 1.98 hr⁻¹ WHSV (based on the constant weight of metal oxide loaded into each reactor), 9,800 scf H₂/bbl; temperatures from about 348.9-393.3° C. (660 to 740° F.) were scanned to in order to bracket the desired conversion range. Online gas GC data were combined with off-line SimDist (D2887) of the liquid product samples to calculate conversion and product yields.

### Example 26

Catalyst D was prepared using ZSM-48 (61 SAR) while Catalyst A was prepared using Y zeolite (52 SAR). As shown in Table 8, Catalyst A exhibited 1.4 wt % greater total distillate yields and 3° C. better activity than catalyst D. Catalyst G was prepared using a 50:50 ratio of ZSM-48 (61 SAR) and Y zeolite (52 SAR). Notice that both activity and yield improved. Catalyst I was prepared using a 67:33 ratio of ZSM-48 (61 SAR) and Y zeolite (52 SAR). Notice that increasing the ratio from 50:50 to 67:33 led to a further increase in total distillate yield, further demonstrating the synergistic effect of having Y and ZSM-48 in close proximity.

TABLE 8
VGO conversion data

| | Temperature (° C.) at 65% Net | Total Distillate Yield (wt % 148.9- |
|---|---|---|
| | Conversion (371.1° C. cut | 371.1° C.) at 65% Net Conversion |
| | point) relative to base case | (371.1° C. cut point) relative |
| | (+ = more active, − = | to base case (+ = higher |
| Catalyst | less active) | yield, − = lower yield) |
| Catalyst D | 0.0 | 0.0 |
| Catalyst A | 3.0 | 1.4 |
| Catalyst G | 3.7 | 2.0 |
| Catalyst I | 4.3 | 2.3 |

### Example 27

All the catalysts in Table 9 were prepared using the same mesoporized Y zeolite and the same ZSM-48. Each reactor contained 3.3 wt % mesoporized CBV-760 and 6.8 wt % PIDC 60 MRE. Catalyst K was prepared by stacking Catalyst C on Catalyst D. Catalyst L was prepared by physically mixing 20×40 meshed catalyst particles of Catalyst C and Catalyst D together. Catalyst J was prepared using the same components that were used to make Catalyst C and D, but in this case, the zeolites were mixed together as powders and formed with the metal oxide. Note that the lowest performance was observed for stacked catalyst (Catalyst K). Performance was improved by physically mixing the components (Catalyst L). However, the best performance was obtained with Catalyst J.

TABLE 9
VGO conversion data

| | Temperature (C.) at 65% Net | Total Distillate Yield (148.9- |
|---|---|---|
| | Conversion (371.1° C. cut | 371.1° C.) at 65% Net Conversion |
| | point) relative to base case | (371.1° C. cut point) relative to |
| | (+ = more active, − = | base case (+ = higher |
| Catalyst | less active) | yield, − = lower yield) |
| Catalyst J | 3.4 | 2.0 |
| Catalyst J | 3.8 | 2.2 |
| (repeat) | | |
| Catalyst L | 1.5 | 0.6 |
| Catalyst K | base | base |

### Example 28

Catalyst D, A, and G were discussed in example 26, but are included herein for comparison. Catalyst G was prepared using a 50:50 ratio of Y zeolite (52 SAR) and ZSM-48 (61 SAR). Catalyst H was again prepared using a 50:50 ratio of Y and ZSM-48, but in this case, each zeolite that was included was separately mesoporized. Notice that compared to Catalyst G, the total distillate yields obtained with Catalyst H are 0.7 wt % higher, the heavy distillate yields are 0.6 wt % higher, and the activity is similar (Table 10). Catalyst F was prepared using a co-mesoporized Y and ZSM-48 zeolite; in that case, since only one mesoporization step is needed, manufacturing costs would be lower. Note that similar total distillate yields were observed for Catalyst H and F; however, catalyst F exhibited slightly higher heavy distillate yields. It should be noted that this yield advantage was observed over a wide conversion range. Catalyst E, which contains mesoporized ZSM-48, exhibited relatively high heavy distillate yields, but the total distillate yields were lower than that observed for the co-mesoporized sample (Catalyst F). The total liquid product from these experiments were evaluated using GC×GC. Results are summarized in Table 11. Notice that the total liquid products for Catalyst E and Catalyst D contain more aromatics than the comparative samples; this is not desired in several applications. The greater isomerization obtained from the combination of Y and ZSM-48 can be seen from the higher iso-paraffin levels present for Catalysts F, G, and H.

TABLE 10
VGO conversion data

| | | Total Distillate Yield | Heavy Distillate Yield |
|---|---|---|---|
| | Temperature (° C.) at | (wt % 148.9-371.1° C.) | (wt % 287.8-371.1° C.) |
| | 65% Net Conversion | at 65% Net Conversion | at 65% Net Conversion |
| | (371.1° C. cut point) | (371.1° C. cut point) | (371.1° C. cut |
| | relative to base case | relative to base case | point) relative to |
| | (+ = more active, − = | (+ = higher yield, − = | base case (+ = higher |
| Catalyst | less active) | lower yield) | yield, − = lower yield) |
| Catalyst D | 0.0 | 0.0 | 0.0 |
| Catalyst A | 3.0 | 1.4 | −2.3 |
| Catalyst G | 3.7 | 2.0 | −0.9 |
| Catalyst H | 2.8 | 2.7 | −0.3 |
| Catalyst F | 0.7 | 2.7 | −0.1 |
| Catalyst E | −0.4 | 1.2 | 0.8 |

TABLE 11
GC x GC Results

| | Net Conversion | Temperature | | | | | | |
|---|---|---|---|---|---|---|---|---|
| | (%, 700F CP) | (° C.) | | | | | | |
| | Relative to | Relative to Base | | | | | | |
| | Base Case | Case (+ = | | | | | | |
| | (+ = higher | higher relative | Total | | Total | | Total | Total |
| | conversion, − = | temperature, − = | mono- | Total di- | iso- | Total n- | mono- | poly- |
| | lower | lower relative | aromatics | aromatics | paraffins | paraffins | naphthenes | naphthenes |
| Catalyst | conversion) | temperature) | (wt %) | (wt %) | (wt %) | (wt %) | (wt %) | (wt %) |
| A | 5.8 | 0.0 | 2.1 | 0.02 | 32.1 | 11.4 | 52.0 | 2.3 |
| D | 0 | 0.0 | 6.2 | 0.05 | 26.7 | 3.5 | 61.4 | 2.1 |
| G | −5 | −5.6 | 3.5 | 0.03 | 31.8 | 7.1 | 55.3 | 2.3 |
| G | 7.6 | 0.0 | 3.2 | 0.03 | 36.0 | 5.3 | 53.7 | 1.7 |
| H | 5.2 | 0.0 | 3.2 | 0.03 | 35.2 | 5.3 | 54.2 | 2.0 |
| F | 1 | 0.0 | 3.3 | 0.03 | 34.1 | 5.5 | 54.8 | 2.3 |
| E | −0.8 | 0.0 | 6.2 | 0.06 | 26.9 | 3.7 | 61.1 | 2.0 |

### Example 29

Catalyst N was prepared using ZSM-48 (111 SAR), and Catalyst A was prepared using Y zeolite (52 SAR). As shown in Table 12, compared to Catalyst N, Catalyst A was notably more active but exhibited lower total distillate yield and lower heavy distillate yields. Catalyst M was prepared using a co-mesoporized zeolite Y (52 SAR) and ZSM-48 (111 SAR) zeolite. Catalyst M exhibited about 9° C. lower activity than Catalyst A, but it exhibited 1.9 wt % higher total distillate yields and 2.2 wt % higher heavy distillate yields.

TABLE 12
VGO conversion data

| | | Total Distillate Yield | Heavy Distillate Yield |
|---|---|---|---|
| | Temperature (° C.) at | (wt % 148.9-371.1° C.) | (wt % 287.8-371.1° C.) |
| | 65% Net Conversion | at 65% Net Conversion | at 65% Net Conversion |
| | (371.1° C. cut point) | (371.1° C. cut point) | (371.1° C. cut |
| | relative to base case | relative to base case | point) relative to |
| | (+ = more active, − = | (+ = higher yield, − = | base case (+ = higher |
| Catalyst | less active) | lower yield) | yield, − = lower yield) |
| Catalyst A | 0.0 | 0.0 | 0.0 |
| Catalyst N | −22.9 | 1.9 | 3.3 |
| Catalyst M | −9.4 | 1.9 | 2.2 |

### Example 30

Catalyst O was prepared using ZSM-23 (38 SAR), and Catalyst A was prepared using zeolite Y (52 SAR). As shown in Table 13, compared to Catalyst O, Catalyst A was notably more active with notably higher total distillate yields, but with lower heavy distillate yields. Catalyst P was prepared using a 50:50 blend of ZSM-23 (38 SAR) and zeolite Y (52 SAR). Notice that compared to Catalyst A, it exhibited slightly lower activity with 0.9 wt % higher total distillate yield and 0.8 wt % higher heavy distillate yields. Catalyst Q was prepared by co-mesoporizing ZSM-23 (38 SAR) and Y zeolite (52 SAR). Although the activity was lower, heavy distillate yields were about 1.3 wt % higher at 50% net conversion. At 65% net conversion, the heavy distillate yield was about 1.7 wt % higher, and the total distillate yield was 0.6 wt % higher. This demonstrates the synergy between Y and ZSM-23 and shows that further improvements can be obtained via co-mesoporization.

TABLE 13
VGO conversion data

| | Temperature (C.) at | Total Distillate Yield | Heavy Distillate Yield |
|---|---|---|---|
| | 50% Net Conversion | 148.9-371.1 C. (300-700 F.) | (287.8-371.1 C.) at 50% |
| | (371.1 C. cut point) | at 50% Net Conversion | Net Conversion (371.1 C. |
| | relative to base case | (371.1 C. cut point) relative | cut point) relative to |
| | (+ = more active, − = | to base case (+ = higher | base case (+ = higher |
| 1 | less active) | yield, − = lower yield) | yield, − = lower yield) |
| Catalyst O | 0.0 | 0.0 | 0.0 |
| Catalyst A | 26.8 | 2.0 | −2.8 |
| Catalyst P | 25.2 | 2.9 | −2.0 |
| Catalyst Q | 16.9 | 3.0 | −0.7 |

### SPECIFIC EMBODIMENTS

While the following is described in conjunction with specific embodiments, it will be understood that this description is intended to illustrate and not limit the scope of the preceding description and the appended claims.

A first embodiment of the invention is a catalyst composition comprising two or more zeolitic materials comprising hierarchical porosity, each zeolitic material having a mesostructure from 2 to 50 nm. An embodiment of the invention is one, any or all of prior embodiments in this paragraph up through the first embodiment in this paragraph wherein the two or more zeolitic materials comprise a blend of two or more mesoporous zeolites, the first zeolite comprising Y zeolite, and the second zeolite comprising a one-dimensional, 10-ring zeolite. An embodiment of the invention is one, any or all of prior embodiments in this paragraph up through the first embodiment in this paragraph wherein the first zeolite comprises post-synthesis mesoporized Y zeolite, and wherein the second zeolite comprises as-synthesized mesoporous one-dimensional, 10-ring zeolite. An embodiment of the invention is one, any or all of prior embodiments in this paragraph up through the first embodiment in this paragraph wherein the first zeolite comprises post-synthesis mesoporized Y zeolite, and wherein the second zeolite comprises post-synthesis mesoporized one-dimensional, 10-ring zeolite. An embodiment of the invention is one, any or all of prior embodiments in this paragraph up through the first embodiment in this paragraph wherein the blend comprises a post-synthesis mesoporized blend of the first zeolite and the second zeolite. An embodiment of the invention is one, any or all of prior embodiments in this paragraph up through the first embodiment in this paragraph wherein the first zeolite is present in an amount in a range of 20% to 75% of a total amount of the first and second zeolites. An embodiment of the invention is one, any or all of prior embodiments in this paragraph up through the first embodiment in this paragraph wherein the first zeolite is present in an amount greater than or equal to 20% of a total amount of the first and second zeolites.

A second embodiment of the invention is a method of making a catalyst composition comprising mesoporizing a first zeolite and blending the mesoporized first zeolite with an as-synthesized mesoporous second zeolite; or mesoporizing a first zeolite, mesoporizing a second zeolite, and blending the mesoporized first zeolite with the mesoporized second zeolite; or blending a first zeolite and a second zeolite, and mesoporizing the blend of the first zeolite and the second zeolite; wherein the first zeolite comprises Y zeolite, and the second zeolite comprises a one-dimensional, 10-ring zeolite. An embodiment of the invention is one, any or all of prior embodiments in this paragraph up through the second embodiment in this paragraph wherein the first zeolite is present in an amount in a range of 20% to 75% of a total amount of the first and second zeolites. An embodiment of the invention is one, any or all of prior embodiments in this paragraph up through the second embodiment in this paragraph wherein the first zeolite is present in an amount greater than or equal to 20% of a total amount of the first and second zeolites.

A third embodiment of the invention is a process comprising hydrocracking and/or hydroisomerizing a feedstock in a hydrocracking or hydroisomerization reaction zone comprising a hydroracking or hydroisomerization reactor in the presence of a hydrocracking and/or hydroisomerization catalyst composition to form a hydrocracked and/or hydroisomerized feedstock; wherein the hydrocracking and/or hydroisomerization catalyst composition comprises two or more zeolitic materials comprising hierarchical porosity, each zeolitic material having a mesostructure from 2 to 50 nm. An embodiment of the invention is one, any or all of prior embodiments in this paragraph up through the third embodiment in this paragraph wherein the two or more zeolitic materials comprise a blend of two or more mesoporous zeolites, the first zeolite comprising Y zeolite, and the second zeolite comprising a one-dimensional, 10-ring zeolite. An embodiment of the invention is one, any or all of prior embodiments in this paragraph up through the third embodiment in this paragraph wherein the first zeolite comprises post-synthesis mesoporized Y zeolite, and wherein the second zeolite comprises as-synthesized mesoporous one-dimensional, 10-ring zeolite. An embodiment of the invention is one, any or all of prior embodiments in this paragraph up through the third embodiment in this paragraph wherein the first zeolite comprises post-synthesis mesoporized Y zeolite, and wherein the second zeolite comprises post-synthesis mesoporized one-dimensional, 10-ring zeolite. An embodiment of the invention is one, any or all of prior embodiments in this paragraph up through the third embodiment in this paragraph wherein the blend comprises a post-synthesis mesoporized blend of the first zeolite and the second zeolite. An embodiment of the invention is one, any or all of prior embodiments in this paragraph up through the third embodiment in this paragraph wherein the first zeolite is present in an amount in a range of 20% to 75% of a total amount of the first and second zeolites. An embodiment of the invention is one, any or all of prior embodiments in this paragraph up through the third embodiment in this paragraph wherein the first zeolite is present in an amount greater than or equal to 20% of a total amount of the first and second zeolites. An embodiment of the invention is one, any or all of prior embodiments in this paragraph up through the third embodiment in this paragraph wherein the feedstock is selected from vacuum gas oil, kerosene, jet fuel, distillate, light cycle oil, naphtha, deasphalted oil, atmospheric gas oil, coker gas oil, Fisher Tropsch wax, Fisher Tropsch oil, lube base oil, biogenic materials, waste fats, oils, and greases or feedstocks such as oil crops, and mixtures thereof.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A catalyst composition comprising:
two or more zeolitic materials comprising hierarchical porosity, each zeolitic material having a mesostructure in a range of 2 to 50 nm.

2. The catalyst composition of claim 1 wherein the two or more zeolitic materials comprise a blend of two or more mesoporous zeolites, the first zeolite comprising Y zeolite, and the second zeolite comprising a one-dimensional, 10-ring zeolite.

3. The catalyst composition of claim 2 wherein the first zeolite comprises post-synthesis mesoporized Y zeolite, and wherein the second zeolite comprises as-synthesized mesoporous one-dimensional, 10-ring zeolite.

4. The catalyst composition of claim 2 wherein the first zeolite comprises post-synthesis mesoporized Y zeolite, and wherein the second zeolite comprises post-synthesis mesoporized one-dimensional, 10-ring zeolite.

5. The catalyst composition of claim 2 wherein the blend comprises a post-synthesis mesoporized blend of the first zeolite and the second zeolite.

6. The catalyst composition of claim 2 wherein the first zeolite is present in an amount in a range of 20% to 75% of a total amount of the first and second zeolites.

7. The catalyst composition of claim 2 wherein the first zeolite is present in an amount greater than or equal to 20% of a total amount of the first and second zeolites.

8. A method of making a catalyst composition comprising:
mesoporizing a first zeolite and blending the mesoporized first zeolite with an as-synthesized mesoporous second zeolite; or
mesoporizing a first zeolite, mesoporizing a second zeolite, and blending the mesoporized first zeolite with the mesoporized second zeolite; or
blending a first zeolite and a second zeolite, and mesoporizing the blend of the first zeolite and the second zeolite;
wherein the first zeolite comprises Y zeolite, and the second zeolite comprises a one-dimensional, 10-ring zeolite.

9. The method of claim 8 wherein the first zeolite is present in an amount in a range of 20% to 75% of a total amount of the first and second zeolites.

10. The method of claim 8 wherein the first zeolite is present in an amount greater than or equal to 20% of a total amount of the first and second zeolites.

11. A process comprising:
hydrocracking and/or hydroisomerizing a feedstock in a hydrocracking or hydroisomerization reaction zone comprising a hydcroracking or hydroisomerization reactor in the presence of a hydrocracking and/or hydroisomerization catalyst composition to form a hydrocracked and/or hydroisomerized feedstock;
wherein the hydrocracking and/or hydroisomerization catalyst composition comprises: two or more zeolitic materials comprising hierarchical porosity, each zeolitic material having a mesostructure from 2 to 50 nm.

12. The process of claim 11 wherein the two or more zeolitic materials comprise a blend of two or more mesoporous zeolites, the first zeolite comprising Y zeolite, and the second zeolite comprising a one-dimensional, 10-ring zeolite.

13. The process of claim 12 wherein the first zeolite comprises post-synthesis mesoporized Y zeolite, and wherein the second zeolite comprises as-synthesized mesoporous one-dimensional, 10-ring zeolite.

14. The process of claim 12 wherein the first zeolite comprises post-synthesis mesoporized Y zeolite, and wherein the second zeolite comprises post-synthesis mesoporized one-dimensional, 10-ring zeolite.

15. The process of claim 12 wherein the blend comprises a post-synthesis mesoporized blend of the first zeolite and the second zeolite.

16. The process of claim 12 wherein the first zeolite is present in an amount in a range of 20% to 75% of a total amount of the first and second zeolites.

17. The process of claim 12 wherein the first zeolite is present in an amount greater than or equal to 20% of a total amount of the first and second zeolites.

18. The process of claim 11 wherein the feedstock is selected from vacuum gas oil, kerosene, jet fuel, distillate, light cycle oil, naphtha, deasphalted oil, atmospheric gas oil, coker gas oil, Fisher Tropsch wax, Fisher Tropsch oil, lube base oil, biogenic materials, waste fats, oils, greases, oil crops, or mixtures thereof.
